(19) United States
(12) Patent Application Publication
(10) Pub. No.: US 2013/0262992 A1
(43) Pub. Date: Oct. 3, 2013

(54) METHODS AND SYSTEMS FOR ELECTRONIC EDITING AND/OR SIGNING

(71) Applicants: Jane HE, Ottawa (CA); Qingbo JIN, Ottawa (CA)

(72) Inventors: Jane HE, Ottawa (CA); Qingbo JIN, Ottawa (CA)

(21) Appl. No.: 13/800,985

(22) Filed: Mar. 13, 2013

Related U.S. Application Data
(60) Provisional application No. 61/618,893, filed on Apr. 2, 2012.

(51) Int. Cl. G06F 17/24

(52) U.S. Cl. CPC G06F 17/24
USPC 715/255

(57) ABSTRACT

The present invention provides methods and systems for electronic signing. The present invention enables a signer, who may be unknown to the document owner, to edit a copy of the document and submit it back to the document owner, or alternatively delete the copy if the signer decides to withdraw its version of the document. The present invention also enables a document owner to have multiple parties at different locations to edit (and sign or execute) a common document in real-time or near real-time. The present invention also enables any interactive communication that can be recorded with a time stamp between the document owner and one or more signers as supporting evidence of the edits made to the document. Examples of this interactive communication may include audio or video recordings of the document (including of the signing event) or a chat board.

### FIELD OF THE INVENTION

The present invention relates to electronic document editing and signing, and processing by one or more parties.

### BACKGROUND

In today's era of pervasive electronic communication, many people and organizations alike are looking for solutions that allow for the signing or execution of agreements between parties through electronic means. The need for these solutions is particularly acute where the parties are not local, or there is some impediment to meeting in person to sign or execute the documents. In addition, legal systems are evolving such that, in some jurisdictions, electronically executed documents are now permissible as evidence. The evolution of legal systems to accept electronically executed documents as admissible evidence has further spurred the need for this technology.

In the United States, for example, the Federal E-SIGN Act came into law on Oct. 1, 2000. The E-SIGN Act makes online electronic signatures in a commercial transaction equivalent to a written signature. In other countries such as the United Kingdom, Canada, Mexico, Sweden, Australia, New Zealand and Singapore, domestic laws state that electronic signatures are, broadly speaking, deemed to be the same as written signatures, so long as the parties agree to use electronic signatures and the electronic signature service used can accurately match the transaction record to the parties and the contract.

Some of the electronic signature needs are being met. However, many currently available solutions require document owners to know their recipient, i.e., the owners must have previous knowledge of the individual or organization through a signing officer(s) who needs to execute the document. Document owners may be individuals or organizations that have either created or are managing the execution of the document.

Some solutions of the prior art require the document owner to know the recipient's email address. For example, when a newcomer wants to register for an activity run by an organization, the document owner, which is the organization, does not necessarily know the newcomers. Currently available methods and systems for electronic signing cannot address this shortcoming.

In addition, the prior art solutions do not address the need for multiple parties to sign or execute the same document in real-time or near real-time. In particular, prior art solutions do not address the issue of electronic signing when witnesses are required for each signature. If witnesses are not in the same room, these solutions cannot guarantee that the documents have been executed in accordance with legal requirements.

Some research studies have suggested using a sophisticated digital encryption and authentication technique, such as the RSA scheme, but this can be quite impractical, especially where one party is unknown to the other.

In addition, agreements between parties, such as contracts, are often amended between the parties through counter offers during negotiations. Many prior art solutions do not able signers to edit the contract before signing, rather the signer must simply sign the version without the option of making any amendments.

In light of the aforementioned shortcomings of the prior art, the present invention seeks to provide methods and systems for electronic signing that address these shortcomings.

### SUMMARY

The present invention provides methods and systems for electronic signing. The present invention enables a signer, who may be unknown to the document owner, to edit a copy of the document and submit it back to the document owner, or alternatively delete the copy if the signer decides to withdraw its version of the document. The present invention also enables a document owner to have multiple parties at different locations to edit (and sign or execute) a common document in real-time or near real-time. The present invention also enables any interactive communication that can be recorded with a time stamp between the document owner and one or more signers as supporting evidence of the edits made to the document. Examples of this interactive communication may include audio or video recordings of the document (including of the signing event) or a chat board.

In a first aspect, the present invention provides a system for electronic editing of a document comprising: a server having processing and memory means and a database; at least one computing device in operative communication with the server, the at least one device having display means to view a copy of the document, and having a user interface to input at least one edit into the copy of the document, wherein the database stores the document, and the processing means generates a copy of the document.

In a second aspect, the present invention provides a method for electronic editing of a document comprising steps of: (a) Receiving a request from an editor for a particular document stored in a database at a server; (b) Generating a copy of the document in the database and assigning a unique identification to the copy; (c) Storing the copy in the database; (d) Providing the editor with electronic access to the copy; (e) Receiving at least one edit to the copy by the editor; and (f) Storing the edited copy of the document in the database.

In a third aspect, the present invention provides system for electronic editing of a document comprising: a server having processing and memory means and a database; at least one computing device in operative communication with the server, the at least device having display means to view a copy of the document, and having a user interface to input at least one edit into the copy of the document; and a recording device, operatively coupled to the at least one computing device, for simultaneously recording an interactive communication related to the at least one edit, wherein the database stores the document and recorded data produced by the recording device, and wherein the processing means generates a copy of the document.

In a fourth aspect, the present invention provides a method for editing an electronic document comprising steps of: (a) Storing a common document in a database on a server; (b) Electronically sending the common document to at least one device in operative communication with the server; (c) Editing the common document at the least one device and simultaneously recording the editing; (d) Updating each of the at least one device with the edited common document; and (e) Storing the edited common document and a recording file of the recording made in step (c).

### BRIEF DESCRIPTION OF THE DRAWINGS

The embodiments of the present invention will now be described by reference to the following figures, in which identical reference numerals in different figures indicate identical elements and in which:

FIG. 1 is a block diagram of an electronic signing system in accordance with a first aspect of the present invention;

FIG. 2 is a flowchart detailing a method in accordance with a first aspect of the present invention;

FIG. 3 is a block diagram of an electronic signing system in accordance with a second aspect of the present invention; and

FIG. 4 is a flowchart detailing a method in accordance with a second aspect of the present invention.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicate that two or more elements are in either direct or indirect (with other intervening elements between them) physical or electrical contact with each other, or that the two or more elements co-operate or interact with each other (e.g. as in a cause and effect relationship).

The term “server” is also used throughout this document. For the purposes of this document, a server includes a processing means, an input and an output means, memory means (such as random access memory), and a database for data storage (such as any data storage unit that would be readily contemplated by the skilled artisan).

For the purposes of this document, the term “edit” and the phrase “editing a document” may mean that a signer makes changes to the document and/or executes or signs the documents. In other words, the step of editing of the document may include the signer actually signing or executing the document.

According to a first aspect of the present invention, a document editing and signing method and system is contemplated. According to the present invention, the signer may be known or unknown to the documenter owner, drafter, and/or co-signer. The document owner generates a template of a particular document to be edited and/or signed, and stores the template in the database. The template is created by the document owner to prepare the document for editing (including signing) by other parties. For example, the document owner may highlight signature boxes.

Access to the document and its corresponding template is provided to the public through a communication channel. The communication channel may be created through, for example, an Internet hyperlink to a website, or through an email exchange or another network linkage.

When a signer (using a device such as a computer) requests a document for editing and signing through a particular communication channel, the system will query the signer to determine unique information about the signer. Based on the above the unique information provided, the present invention generates a unique document identification (ID). The unique ID may be a combination of answers from signer's first time login and ID generated by the system. The unique ID is a combination of answers from signer's first time login and ID generated by the system. For example, the name of the signer and the email address of the signer may be used in combination as a unique ID for its copy of the document: signer_name+template_name+random_unique_number, etc.

Following that, the database makes a copy of the document based on the template and assigns a unique ID to that signer that forms part of its copy of the document. The copy of the template is sent from the database to the signer as a first document assigned to that first signer through a secured or unsecured link or network interconnection. According to an alternative aspect of the present invention, an electronic message may be sent to the signer requesting further personal information, such as a cell phone number, for use when the signer returns to the system.

Next, the signer then completes editing and signing of the first document. The revised first document is then stored in the server's database. In an alternative embodiment, the present invention may generate and send a confirmation to the signer at its device, for example through e-mail or short message service (SMS) or other communication methods to acknowledge a specific signature or edit has been applied. This confirmatory communication is helpful in that it can serve to confirm that the person who signed the document is the person on record with the document owner.

By way of example, a school waiver form is posted on a school website. Anyone is invited to sign a copy of the form. Once the school receives a waiver form from a parent signer, the present invention is able to send a confirmatory email to the parent at their officially registered email address. The parent can then acknowledge the e-mail to confirm that they actually signed a copy of the form. This is a useful option to avoid certain fraudulence or misrepresentation.

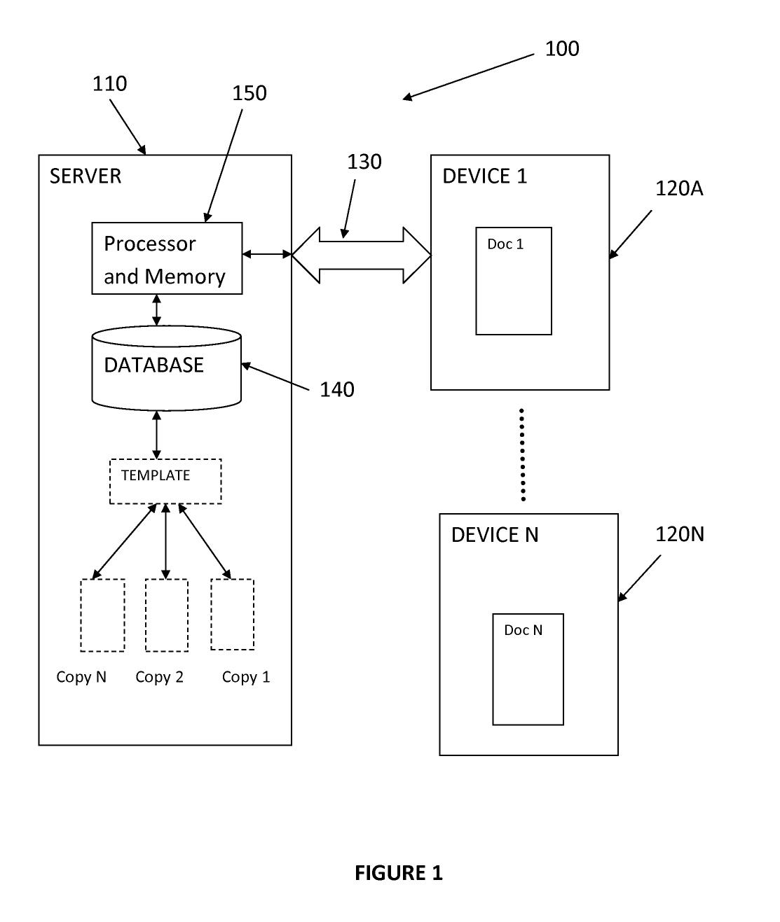

FIG. 1 shows an electronic signing system 100 in accordance with a first aspect of the present invention. The system 100 includes a server 110, at least one remote device 120A, 120N, and a communication means 130. The server 110 generally includes, although not limited to as explained previously, a database 140 and processing and memory means 130. According to the present invention, the remote device 120A is in operative communication with the server 110 through the communication means 130. The processing and memory means 150 are operatively coupled to the database 140.

The communication means 130 may include any wired or wireless form of communication. The remote device 120A may be a handheld device or a desktop computer or any other device type that would be readily contemplated by the skilled artisan.

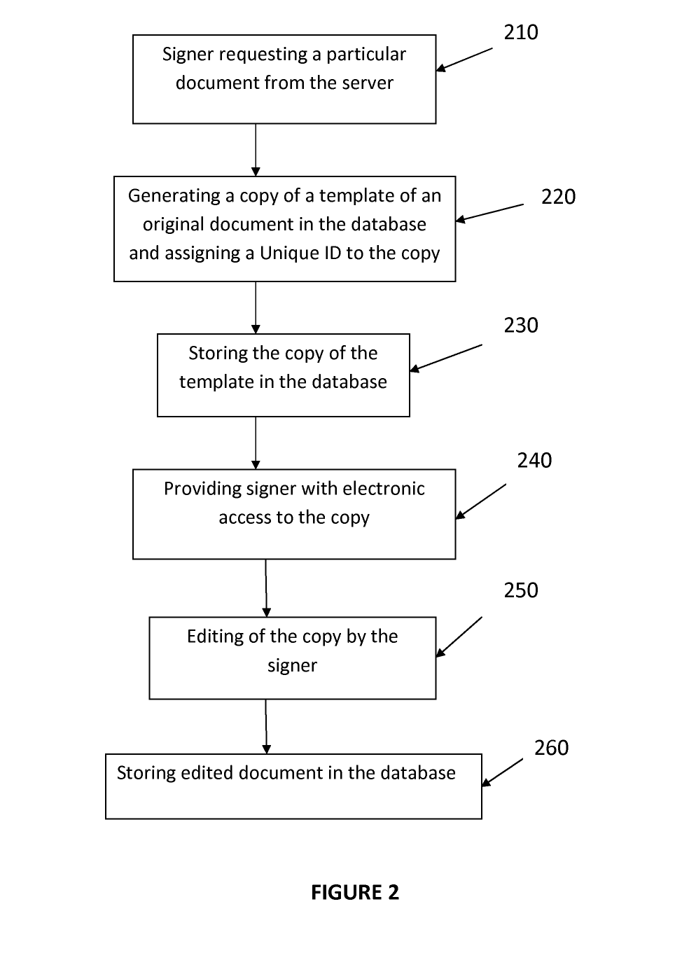

FIG. 2 is a flowchart detailing a method in accordance with a first aspect of the present invention. The method begins at step 210 with the signer requesting a particular document from the server. Next, step 220 is performed by the server generating a copy of the original document that the signer is requesting in step 210, based on the original document or on a template of the original document if one has been created by the document owner. Step 220 also involves assigning a unique identification (ID) to the signer and its copy of the document. Following step 220, step 230 involves storing the copy in the database along with its unique ID. Next step 240 involves providing the signer with electronic access to the copy for editing purposes. Step 250 is the editing step in which the signer is able to edit and/or sign/execute the document. Finally, step 260 involves storing the edited copy of the document in the database.

It should be further mentioned that step 220, or a previous step in the method (not detailed), may involve generating a template by the document owner. The template may be identical to the original document. The template serves to reduce administration work. As such, either the template or the original document may be copied.

By way of an example, each parent registering a child for a city soccer club can access a city's soccer registration form through a secure website. Each parent would then edit and/or sign a uniquely assigned copy of the same original document, or a template of the same original document. The present invention is advantageous in that the city club does not know in advance who the signers will be and they do not need to. As discussed in the background, many prior art solutions for electronic signing require the document owner to know its signers in advance.

As mentioned previously, the copy of the template of the original document name is assigned a unique ID that is associated with a particular signer. It should be readily understood that the same signer may have different have edited different copies of documents, and as such a unique ID is associated with each different copy.

In accordance with another embodiment of the present invention, documents for each document owner may be automatically organized in a designated folder for each document owner with different file names for each version. For example, the signer may not complete editing of its copy of the document in one attempt and may need to access the server at a later date to complete edits. By organizing documents in a particular hierarchy, copies of documents may be more readily retrieved.

As shown in FIG. 1, the present invention contemplates a plurality of devices, devices 1 through N, 120A and 120N being operatively coupled to the server, whereby a signer at a particular device may request the same document as another signer using another device. By generating a plurality of copies (copy 1, copy 2, through copy N), multiples signers have the opportunity to edit or sign a copy of the same original document.

The document owner may generate a template by preparing signature boxes, or a text input area, etc. The signer may then access the server and edit the highlighted or outlined editing and signing fields to fill in the requested information. The template does not preclude the signer from inserting its own edits. For example, the signer may want to change some language in the document because the signer will not agree to signing the document as worded by the document owner.

For electronic signing, the present invention contemplates several different ways. For example, personal computer (PC) or laptop users may use, for example, an internal or external mouse, or a finger pad, or an external drawing device connected to the PC to sign biometrically. Alternatively, a type-to-sign feature that is known to the skilled artisan may be used. A previously saved digital signature may also be used. For tablet computer, electronic reader, or handheld (mobile) device users, a touch screen or stylus in another option to generate a personal signature.

According to a second aspect of the present invention, a real-time multi-party electronic signing method and system is provided. According to the present invention, a common document for one or more parties to edit is stored on a server. Any remotely located device that can operatively communicate with the server to view the document simultaneously. After a particular device edits the document locally, that device sends back the edits to the server. The server in turn sends the edits back to all devices and updates the local documents in real-time, or near real-time. To clarify, every edit made by a signer is sent back to the server. The server then broadcasts the edit to all signers of the same document, regardless of whether they are online or not. This feature is very similar to the “share” feature in the proprietary Google Docs™. When a document is shared by multiple people, everybody can see changes.

Each local device may record a video of the signer editing the document. The video is then uploaded to the server for storage of the video in the database. The recorded video is stored with a time and user ID stamp. Each video recording can be retrieved from the database and played back. When video recording option is not available to the local device, audio may be recorded by the local device and uploaded as an audio file to the server. The database may also store audio files from all devices.

An audio recording may serve to capture a conversation between the signing parties. Audio conversations may be realized through proprietary built-in or existing audio conference solutions. For example, the well-known Skype™ conferencing service, or the Microsoft MSN™ may be incorporated by the present invention. Any audio/video data capture will be time stamped by the server's timer. If the recording is through a third party application, the recorded file is time stamped when received by the server. This timestamp may vary depending on when local signer transmits the recording to the server.

The audio recording differs from the video recording in that a signer can readily mute the microphone to prevent recording for a particular period of time. With a video recording, visual images are still being recorded regardless of whether the microphone on the recorder is muted. As with video files, audio files may also be played back. The video and audio are important in that they provide a record that substantiates which party has edited (including signed) a particular document and the date and time at which one or more edits were made. In other words, the signing event is recorded for proof later that the editing (including signing or execution) of the document actually took place. Video recordings can be particularly helpful to show that, for example, the signing officer for a particular company actually signed the document. Video recording provides an advantageous feature in that the signer can view all participants. As such, the signer may record other participants. If all signers transmit the recorded video files back to the server, there would be N video files (not shown) that can be used to validate each other recording. If a video conference call is not performed, each signer may generate its own video file at its site simultaneous to other signers. However, for audio recordings, only one audio file at one time may be established. The audio recording may also be used to validate the video recording(s).

This second aspect of the present invention also contemplates saving or recording any interactive communication, between signers reviewing a common document, with a time stamp. Each saved or recorded file will be stored as embedded history within the document. This interactive communication history may be useful at a later date to further evidence agreement between the parties before signing a document, for example.

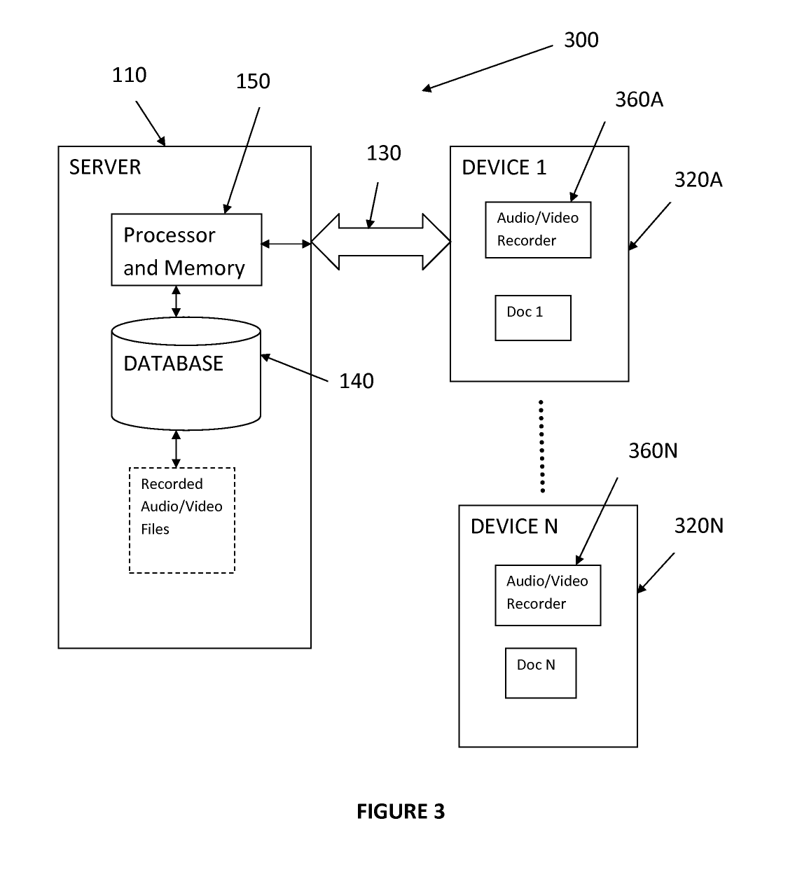

FIG. 3 shows an electronic signing system 100 in accordance with a second aspect of the present invention. The system 300 includes a server 110, at least one remote device 320A, 320N, and a communication means 130. The server 110 generally includes, although not limited to as explained previously, a database 140 and processing and memory means 130. According to the present invention, the remote device 320A is in operative communication with the server 110 through the communication means 130. The processing and memory means 150 are operatively coupled to the database 140.

As in the first aspect, the communication means 130 of the second aspect may include any wired or wireless form of communication. According to the second aspect, the remote device 120A may be a handheld device or a desktop computer or any other device type that would be readily contemplated by the skilled artisan.

Each device, 320A through 320N, includes a recorder 360A, 360N. Each recorder is set up to record audio or video or any other interactive communication, such as a (communal) chat board. Any audio recorder or video camera (with or without audio recording capability) may be utilized for recording audio or video, respectively. For example, a webcam made by Logitech™ may be used for video recording. These webcams generally have a microphone so video, audio, or both may be recorded.

It should be further mentioned that although multiple devices are shown in FIG. 3, the present invention also contemplates the use of a single device.

It should be further mentioned that the present invention also applies to a peer-to-peer network setting. In other words, the present invention creates a mesh interconnection. Any of the devices may broadcast document modification, and the other of devices will update their local document in real time.

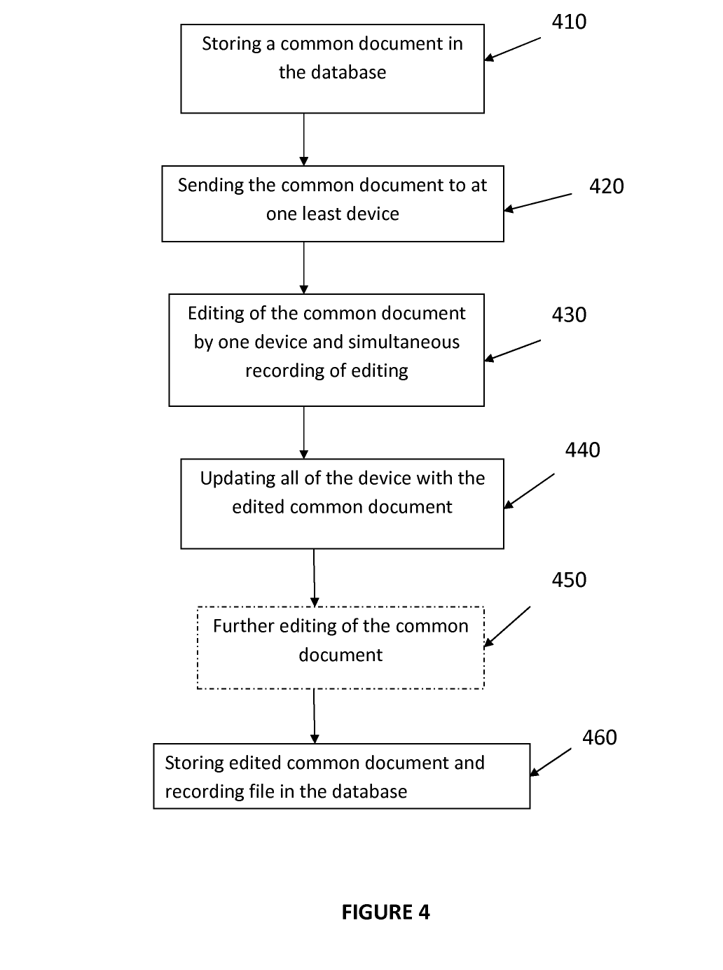

FIG. 4 is a flowchart detailing a method in accordance with a second aspect of the present invention. The method begins at step 410 with storing a common document in the database. This is the common document that will be edited by one or more parties. Alternatively, the original document creator may have created a template document from which a copy may be edited by one or more parties.

The next step 420 is for the server to send to one or more parties, i.e., editors or signers of the document, the common document at their respective device. At step 430, the common document is edited by one device and that editing is simultaneously recorded by that same device through audio or video (or both) recording means. Step 440 updates all of the other devices with the edits made to the common document, so that each device can view the edits being made in real-time or near real-time. Step 450 is an optional step of further editing of the common document by one or more of the parties. After a first edit has been made at step 430, other parties may need to further edit the document, e.g., all of the parties may need to sign the document. Finally the method ends at step 460 when all of the edits have been made. Step 460 the edited common document is stored in the database, along with recording files.

As mentioned previously, the present invention contemplates recording any interactive communication between parties. For example, a chat board may be utilized and its conversation recorded. The present invention contemplates utilizing either a chat board that is either a part of the application or a thirdy party real-time chat application to either invite authorized document signing participants or to serve as a place for discussion or commentary log. The chat board generates a text file with a signer's ID and timestamp for each communication line. Thus, there may be up to N number of text files corresponding to up to N number of chat boards for each signer participating the chat. However, the content of each chat board should be identical between the parties privy to the same chat.

According to the second aspect of the present invention, known and unknown parties may be signers of the document. By enabling multiple parties to sign the document in real-time or near real-time, administrative time for preparation, processing and management of document editing by multiple parties is significantly reduced over prior art or the traditional in-person solution.

It should be further mentioned that the first and the second aspects of the present invention may be embedded or incorporated in part or wholly into other electronic signing methods and systems. For example, a university enrolment administrator prepared a new student registration form and posted the link to the university website. In the form, it requires a student to sign first and for the student's parent to sign its consent. Through the present invention, the administrator may log into the system and witness the real-time signing process by either student or the parents at any time.

One important advantage of the present invention is that in respect of the second aspect, other parties are privy seeing changes being made to a particular document in real-time, or near real-time, and can provide feedback on the changes relatively quickly to avoid any disagreeable changes.

It should be understood that the audio and/or video recording files may be used as an electronic evidence of the signing event in a court of law, for example, to defend the validity of the agreement.

It should also be readily understood by those skilled in the art that a combination of the first and the second aspects of the present invention is possible, e.g., signing by unknown parties embedded with recorded real-time signing or signing in series by multiple parties.

The present invention may be written, but not limited to using HTML5, JavaScript, Java and/or Ajax at the client end to support cross platforms of a variety of PCs and mobile devices.

The present invention may also incorporate new media, an application programming interface (API), a cross platform, security layers at the server and future visualization capabilities. At the device, the installation is not any different between enterprise and individual services.

In an office or a home environment, the following hardware and software can be utilized:

1) a computing device, such as a generic personal computer (PC) or tablet with web browsing capability;

2) an external USB pen for desktop/laptop or stylus for tablet or touch screen;

3) a generic video camcorder; and

4) a phone conference bridge or Internet conference service, such as Skype™.

It should be mentioned that the present invention may be provided as a cloud based-solution, or as a hosted enterprise solution. There is no special requirements since office or home has already equipped with

It should be further mentioned that, according to the first and second aspects, the document copy or common document that is edited (and/or signed) by one or more parties may be stored as a password protected file in the database.

For ID authentication, the present invention contemplates as one alternative that the signer will receive two e-mail notifications. The first e-mail provides a link to the document, and the second e-mail provides for a password to login to a secured website. Other notification types are also contemplated by the present invention, such as SMS, etc.

The present invention also contemplates providing a signature certificate with historical information, including the time stamp for the signature and the IP address of the signer. Biometric signature analysis or facial recognition techniques are also contemplated by the present invention as security features.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for electronic editing of a document comprising:
a server having processing and memory means and a database; and
at least one computing device in operative communication with the server, the at least one device having display means to view a copy of the document, and having a user interface to input at least one edit into the copy of the document; and
wherein the database stores the document, and the processing means generates the copy of the document.

2. A system as in claim 1, wherein the at least one computing device is selected from a group consisting of: a handheld device, a desktop computer, a networking display device, an electronic reader, and a tablet computing device.

3. A system as in claim 1, wherein the operative communication is provided through an Internet connection.

4. A system as in claim 1, wherein the operative communication is provided through a wired network connection.

5. A system as in claim 1, wherein the at least one edit includes a signature of the copy by the signer.

6. A method for electronic editing of a document comprising steps of:
(a) Receiving a request from an editor for a particular document stored in a database at a server;
(b) Generating a copy of the document in the database and assigning a unique identification to the copy;
(c) Storing the copy of the document in the database;
(d) Providing the editor with electronic access to the copy;
(e) Receiving at least one edit to the copy by the editor; and
(f) Storing the edited copy of the document in the database.

7. A method as in claim 6, further including the step of generating a template of the document, such that the copy of the document is based on the template generated and the template directs the signer on how to edit the copy.

8. A system for electronic editing of a document comprising:
a server having processing and memory means and a database;
at least one computing device in operative communication with the server, the at least device having display means to view a copy of the document, and having a user interface to input at least one edit into the copy of the document; and
a recording device, operatively coupled to the at least one computing device, for simultaneously recording an interactive communication related to the at least one edit;
wherein the database stores the document and recorded data produced by the recording device, and wherein the processing means generates a copy of the document.

9. A system as in claim 8, wherein the at least one computing device is a plurality of computing devices at different remote locations.

10. A system as in claim 8, wherein the recording device is an audio recorder for recording sound waves related to inputting of at least one edit.

11. A system as in claim 8, wherein the recording device is a video recorder for recording images related to inputting of at least one edit.

12. A system as in claim 8, wherein the at least one computing device is selected from a group consisting of: a handheld device, a desktop computer, a networking display device, an electronic reader, and a tablet computing device.

13. A system as in claim 8, wherein the operative communication is provided through an Internet connection.

14. A system as in claim 8, wherein the operative communication is provided through a wired network connection.

15. A system as in claim 8, wherein the at least one edit includes a signature of the copy by the signer.

16. A system as in claim 8, wherein the copy is edited by the plurality of computing devices through respective user interfaces.

17. A system as in claim 8, wherein the edited copy is stored in the database as a password protected file.

18. A system as in claim 8, herein the system is connected as a peer-to-peer network in a mesh interconnection.

19. A method for editing an electronic document comprising steps of:
(a) Storing a common document in a database on a server;
(b) Electronically sending the common document to at least one device in operative communication with the server;
(c) Editing the common document at the least one device and simultaneously recording the editing;
(d) Updating each of the at least one device with the edited common document; and
(e) Storing the edited common document and a recording file of the recording made in step (c).

20. A method as in claim 19, wherein step (d) further includes repeating step (c) until all edits are completed on the common document.

21. A method as in claim 19, wherein step (c) of editing includes signing the common document and simultaneously recording the signing.

22. A method as in claim 19, wherein step (c) of recording the editing includes recording any interactive communication between the at least one device.
